(19) United States
(12) Patent Application Publication
(10) Pub. No.: US 2022/0343216 A1
(43) Pub. Date: Oct. 27, 2022

(54) INFORMATION PROCESSING APPARATUS AND INFORMATION PROCESSING METHOD

(71) Applicant: Panasonic Intellectual Property Management Co., Ltd., Osaka (JP)

(72) Inventor: Ryo OKUMURA, Osaka (JP)

(21) Appl. No.: 17/857,204

(22) Filed: Jul. 5, 2022

Related U.S. Application Data
(63) Continuation of application No. PCT/JP2020/031475, filed on Aug. 20, 2020.

(30) Foreign Application Priority Data
Jan. 10, 2020 (JP) 2020-003036

(51) Int. Cl. G06N 20/00; G06K 9/62

(52) U.S. Cl. CPC G06N 20/00; G06K 9/6298; G06K 9/628

(57) ABSTRACT

An information processing apparatus includes: a memory that stores first and second series data; and a processor that performs machine learning of a state space model and an identification model, by calculating a loss function for each model, based on the first and second series data. The state space model includes: an encoder that calculates a state to be inferred based on either one of at least part of the first series data or at least part of the second series data; a decoder that reconstructs at least part of the first and second series data from the state; and a transition predictor that predicts a transition of the state. The identification model identifies whether the state is based on the first series data or the second series data. The loss function of the state space model includes a term that deteriorates accuracy of identification by the identification model.

### BACKGROUND

### 1. Technical Field

The present disclosure relates to an information processing apparatus and an information processing method using machine learning.

### 2. Related Art

JP 5633734 B discloses a technology of causing an agent such as a robot to imitate an action of another person. A model learning unit of JP 5633734 B performs learning for self-organizing a state transition prediction model having a transition probability of a state transition between internal states using first time-series data. The model learning unit further performs learning of the state transition prediction model after performing learning using the first time-series data by using second time-series data with the transition probability fixed. As a result, the model learning unit obtains the state transition prediction model having a first observation likelihood that each sample value of the first time-series data is observed and a second observation likelihood that each sample value of the second time-series data is observed.

Bradly C. Stadie et al., “Third-Person Imitation Learning”, arXiv preprint arXiv: 1703.01703, March 2017 (hereinafter “Non-Patent Document 1”) proposes a technique called third person imitation learning. The third person relates to providing a demonstration of a teacher achieving the same goal as the training of the agent from a different viewpoint. This technique uses a feature vector extracted from an image to determine whether features are extracted from a locus of an expert or a locus of a non-expert, and to identify whether the domain is an expert domain or a novice domain. At this time, domain confusion loss is given so as to destroy information useful for distinguishing the two domains, thereby attempting to achieve domain-agnostic determination.

### SUMMARY

The present disclosure provides an information processing apparatus and an information processing method that can facilitate imitation learning.

An information processing apparatus according to one aspect of the present disclosure includes a memory and a processor. The memory stores first series data including a plurality of pieces of observation data and second series data different from the first series data. The processor performs machine learning of a state space model and an identification model that are learning models, by calculating a loss function for each learning model, based on the first and second series data. The state space model includes: an encoder that calculates a state inferred based on either one of at least part of the first series data or at least part of the second series data; a decoder that reconstructs at least part of the first and second series data from the state; and a transition predictor that predicts a transition of the state. The identification model identifies whether the state is based on the first series data or the second series data. The loss function of the state space model includes a term that deteriorates accuracy of identification by the identification model.

An information processing apparatus according to another aspect of the present disclosure includes a memory and a processor. The memory stores first series data including a plurality of pieces of observation data and second series data different from the first series data. The processor performs machine learning of a state space model that is a learning model, by calculating a loss function of the learning model, based on the first and second series data. The state space model includes: an encoder that calculates a state inferred based on either one of at least part of the first series data or at least part of the second series data; a decoder that reconstructs at least part of the first and second series data from the state; and a transition predictor that predicts a transition of the state. The processor inputs domain information into at least one of the decoder or the encoder to perform machine learning of the state space model, the domain information indicating one type among types classifying data as the first series data or the second series data.

These general and specific aspects may be achieved by a system, a method, and a computer program, and a combination thereof.

According to an information processing apparatus and an information processing method of the present disclosure, it is possible to facilitate imitation learning.

### BRIEF DESCRIPTION OF THE DRAWINGS

FIGS. 1A and 1B are diagrams illustrating a robot system according to a first embodiment of the present disclosure;

FIG. 2 is a block diagram illustrating a configuration of an information processing apparatus according to the first embodiment;

FIG. 3 is a block diagram illustrating a functional configuration of a learning phase in the information processing apparatus;

FIG. 4 is a diagram illustrating a data structure of expert data in the information processing apparatus;

FIG. 5 is a diagram illustrating a data structure of agent data in the information processing apparatus;

FIG. 6 is a block diagram illustrating a functional configuration of an execution phase in the information processing apparatus;

FIG. 7 is a diagram illustrating a configuration of a state space model in the information processing apparatus;

FIG. 8 is a diagram illustrating a graphical model of the state space model in the information processing apparatus;

FIG. 9 is a flowchart illustrating imitation learning processing in the information processing apparatus;

FIG. 10 is a flowchart illustrating processing of a control model in the information processing apparatus;

FIG. 11 is a graph illustrating a first experimental result regarding imitation learning of the first embodiment;

FIG. 12 is a graph illustrating a result in a case of using domain information in a second experiment of the first embodiment;

FIG. 13 is a graph illustrating a result in a case of using no domain information in the second experiment of the first embodiment; and

FIG. 14 is a table illustrating a third experimental result regarding imitation learning of the first embodiment.

### DESCRIPTION OF EMBODIMENTS

Hereinafter, embodiments will be described in detail with reference to the drawings as appropriate. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art. Note that the applicant provides the accompanying drawings and the following description in order for those skilled in the art to fully understand the present disclosure, and does not intend to limit the subject matter described in the claims.

### Findings to the Present Disclosure

Prior to specifically describing embodiments of the present disclosure, first, findings to the present disclosure will be described.

In the technique of JP 5633734 B, after the learning of the state inference and the transition model based on the first series data, the state inference model of the second series data is trained with the transition model fixed, thereby attempting to extract a common state from the first and second series data. However, this conventional technique has a problem in that there is no assurance that the state inferred from the first series data can also be inferred from the second series data. For example, in a case where the positions of the cameras are different between the first series data and the second series data, a feature point of an object that has been visible in the first series data may not be visible in the second series data due to parallax, resulting in a failure.

In contrast to this, the present disclosure provides a technique of imitation learning capable of avoiding the problem as described above. Specifically, the present technique optimizes a state space model described below with respect to both the first series data and the second series data. Therefore, the problem as described above does not occur, and it makes possible to infer, as a state, the feature value that can be extracted from both the first series data and the second series data.

In the technique of Non-Patent Document 1, it is assumed that the locus of an expert (i.e., success data) and the locus of a non-expert (i.e., failure data) are sufficiently collected in advance in the expert domain. However, in general, as compared with the success data, the failure data has so various modes that it is difficult to sufficiently collect failure data of all modes.

In contrast to this, the present disclosure provides a technique of imitation learning capable of avoiding the difficulty as described above. That is, the present technique can be implemented without particularly collecting failure data in advance. In the present technique, as will be described later, by including a term that deteriorates the determination accuracy of the identification model in the loss function of the state space model, information on the domains that are irrelevant to the content desired to be controlled can be automatically removed from the state acquired by learning. As a result, transition prediction of the state and the like are also naturally made highly accurate. Such a mechanism is a novel idea not found in the conventional techniques.

### First Embodiment

Hereinafter, a first embodiment of an information processing apparatus and an information processing method for achieving imitation learning of the present disclosure will be described with reference to the drawings.

### 1. Configuration

### 1-1. System Overview

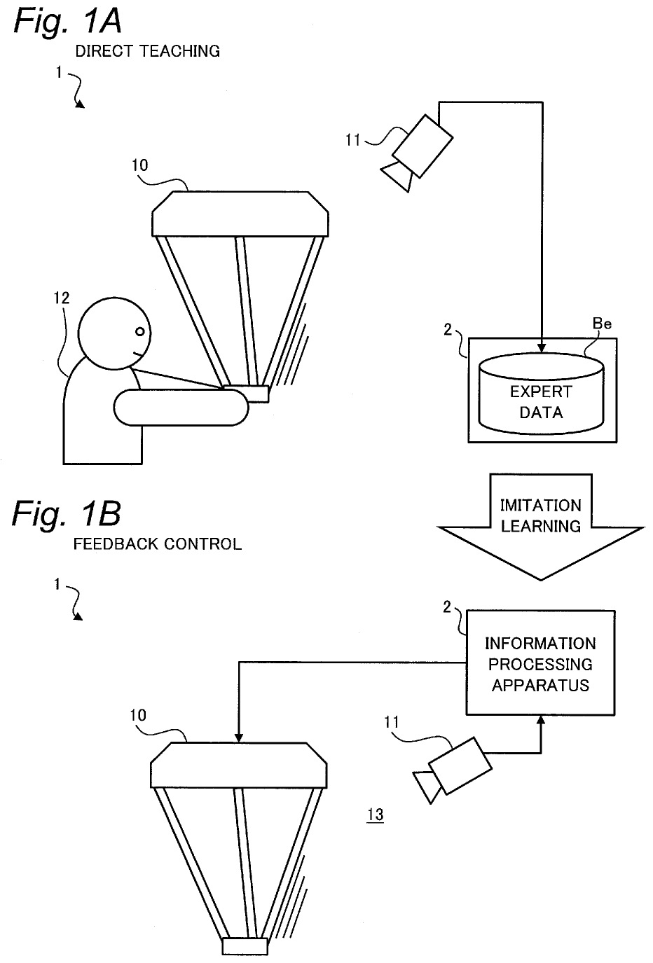

A system to which the information processing apparatus according to the present embodiment is applied will be described with reference to FIGS. 1A and 1B.

FIGS. 1A and 1B illustrate a robot system 1 according to the present embodiment. For example, the robot system 1 of the present embodiment includes a robot 10, a camera 11 that is an example of a sensor device that observes the robot 10, and an information processing apparatus 2, as illustrated in FIGS. 1A and 1B. The system 1 is a system that controls a robot 10 so that desired work is automatically performed by applying imitation learning, which is a type of machine learning, to the information processing apparatus 2.

FIG. 1A illustrates a situation of direct teaching in the system 1. The robot system 1 of the present embodiment has a direct teaching function capable of manually teaching desired work by a human 12. In the direct teaching function, the system 1 captures with the camera 11 a video of the robot 10 being moved by hand of the human 12 or the like, to generate expert data Be on the basis of the captured image. The expert data Be is data indicating a model (i.e., an expert) to be imitated in the imitation learning of the information processing apparatus 2.

FIG. 1B illustrates a situation of feedback control of the robot 10 in the present system 1. In the system 1, the information processing apparatus 2 that has performed learning as described above feedback-controls the robot 10, based on a video of the robot 10 captured by the camera 11 at a work site 13, as illustrated in FIG. 1B for example. The imitation learning of the present embodiment causes the information processing apparatus 2 to acquire a control rule of the robot 10 for executing such feedback control.

In such imitation learning, it is anticipated that there is a domain difference, that is, a domain shift due to various external factors between the expert data Be and the data of the actual work site 13 or the like. For example, in the expert data Be by the direct teaching function, it is conceivable that a finger or the like of the human 12 is reflected in an image. In this case, the presence or absence of the finger or the like is dominant in the feature value of the image, resulting in adversely affecting the imitation learning. The similar problem occurs in a case where the expert data Be is collected in advance in a laboratory in order to perform the imitation learning at the work site 13, for example.

The conventional imitation learning has insufficient measures against such a domain shift, so that it is difficult to practically use the imitation learning such as difficulty to acquire the feedback control law as described above. Therefore, the present embodiment provides the information processing method and the information processing apparatus 2 capable of facilitating imitation learning even if there is a domain shift.

### 1-2. Configuration of Information Processing Apparatus

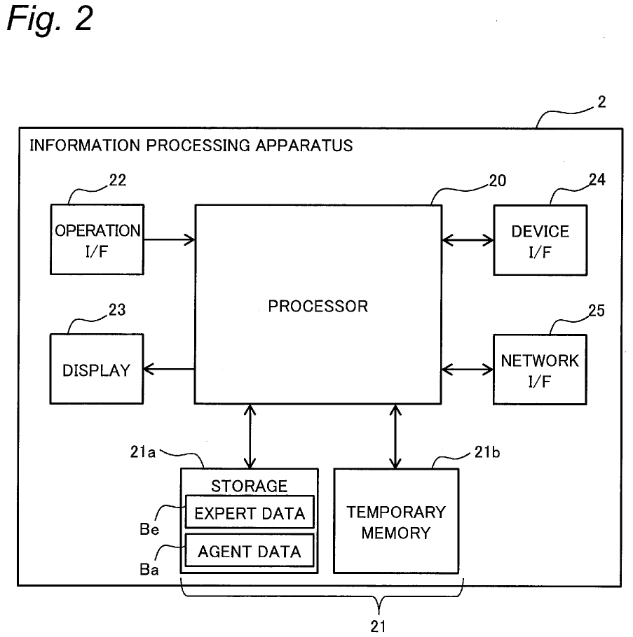

A configuration of the information processing apparatus 2 in the present embodiment will be described with reference to FIG. 2. FIG. 2 is a block diagram illustrating a configuration of the information processing apparatus 2.

The information processing apparatus 2 includes a computer such as a PC, for example. The information processing apparatus 2 illustrated in FIG. 2 includes a processor 20, a memory 21, an operation interface 22, a display 23, a device interface 24, and a network interface 25. Hereinafter, the interface may be abbreviated as an “I/F”.

The processor 20 includes e.g. a CPU or an MPU that achieves a predetermined function in cooperation with software, and controls the overall operation of the information processing apparatus 2. The processor 20 reads data and programs stored in the memory 21 and performs various arithmetic processing, to achieve various functions.

For example, the processor 20 executes a program including instructions for achieving a function of a learning phase or an execution phase, or an information processing method of the information processing apparatus 2 in machine learning. The above program may be provided from a communication network such as the Internet, or may be stored in a portable recording medium.

The processor 20 may be a hardware circuit such as a dedicated electronic circuit or a reconfigurable electronic circuit designed to achieve each of the above-described functions. The processor 20 may be configured by various semiconductor integrated circuits such as a CPU, an MPU, a GPU, a GPGPU, a TPU, a microcomputer, a DSP, an FPGA, and an ASIC.

The memory 21 is a storage medium that stores programs and data necessary for achieving the functions of the information processing apparatus 2. As illustrated in FIG. 2, the memory 21 includes a storage 21a and a temporary memory 21b.

The storage 21a stores parameters, data, control programs, and the like for achieving a predetermined function. The storage 21a includes e.g. an HDD or an SSD. For example, the storage 21a stores the program, the expert data Be, agent data Ba, and the like. The agent data Ba is data indicating an agent that performs learning to imitate the expert indicated by the expert data Be in the imitation learning.

The temporary memory 21b includes e.g. a RAM such as a DRAM or an SRAM, to temporarily store (i.e., holds) data. For example, the temporary memory 21b holds the expert data Be or the agent data Ba and functions as a replay buffer of each of the data Be and Ba. The temporary memory 21b may function as a work area of the processor 20, and may be configured as a storage area in an internal memory of the processor 20.

The operation interface 22 is a generic term for operation members operated by a user. The operation interface 22 may constitute a touch panel together with the display 23. The operation interface 22 is not limited to the touch panel, and may be e.g. a keyboard, a touch pad, a button, a switch, or the like. The operation interface 22 is an example of an input interface that obtains various information input by an operation by a user.

The display 23 is an example of an output interface including e.g. a liquid crystal display or an organic EL display. The display 23 may display various information such as various icons for operating the operation interface 22 and information input from the operation interface 22.

The device I/F 24 is a circuit for connecting an external device such as the camera 11 and the robot 10 to the information processing apparatus 2. The device I/F 24 is an example of a communication interface that communicates data accordance with a predetermined communication standard. The predetermined standard includes USB, HDMI (registered trademark), IEEE1394, WiFi, Bluetooth, and the like. The device I/F 24 may constitute an input interface that receives various information or an output interface that transmits various information to an external device in the information processing apparatus 2.

The network I/F 25 is a circuit for connecting the information processing apparatus 2 to a communication network via a wireless or radio communication line. The network I/F 25 is an example of a communication interface that communicates data conforming to a predetermined communication standard. The predetermined communication standard includes communication standards such as IEEE 802.3 and IEEE 802.11a/11b/11g/11ac. The network I/F 25 may constitute an input interface that receives various information or an output interface that transmits various information via a communication network in the information processing apparatus 2.

The configuration of the information processing apparatus 2 as described above is an example, and the configuration of the information processing apparatus 2 is not limited thereto. The information processing apparatus 2 may include various computers including a server device. The information processing method of the present embodiment may be performed in distributed computing. The input interface in the information processing apparatus 2 may be implemented by cooperation with various software in the processor 20 and the like. The input interface in the information processing apparatus 2 may obtain various information by reading the various information stored in various storage media (e.g., the storage 21a) to a work area (e.g., the temporary memory 21b) of the processor 20.

### 1-3. Details of Configuration

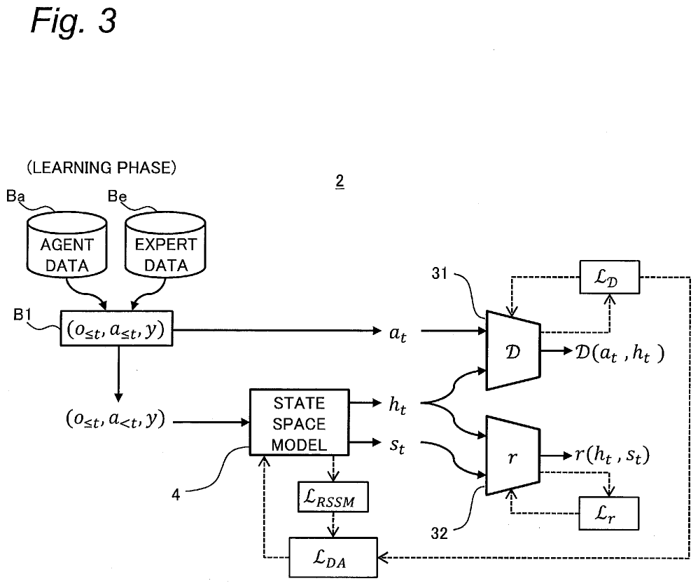

Details of the configuration of the information processing apparatus 2 according to the present embodiment will be described with reference to FIGS. 3 to 6.

FIG. 3 is a block diagram illustrating a functional configuration of a learning phase in the information processing apparatus 2. The information processing apparatus 2 includes a state space model 4, an identification model 31, and a reward model 32 as functional configurations of the processor 20, for example.

In the learning phase, the information processing apparatus 2 operates, for example, by alternately using the agent data Ba and the expert data Be as input series data B1. Hereinafter, an operation in which the input series data B1 is the agent data Ba is referred to as an agent operation, and an operation in which the input series data B1 is the expert data Be is referred to as an expert operation.

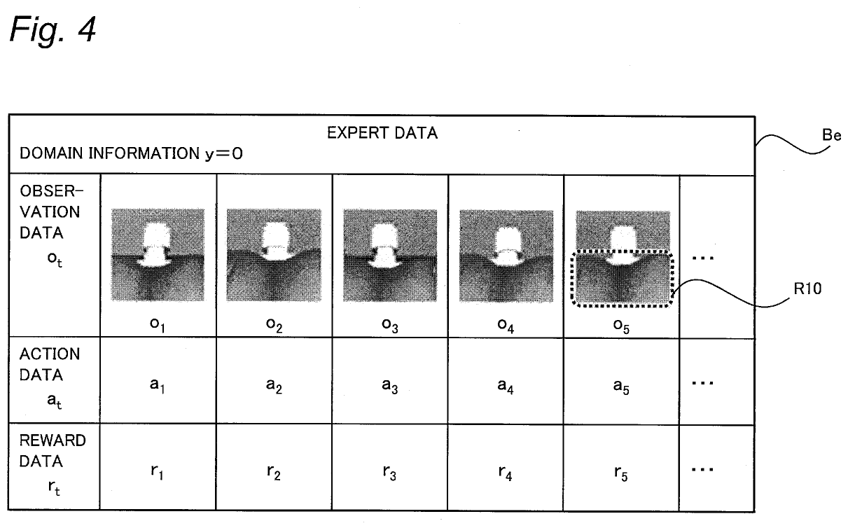

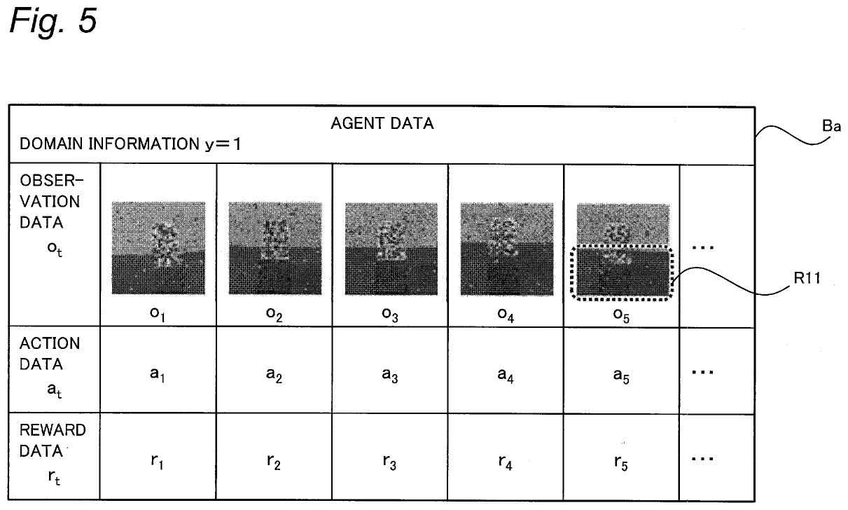

FIG. 4 is a diagram illustrating a data structure of the expert data Be in the present embodiment. FIG. 5 illustrates a data structure of the agent data Ba.

In the present embodiment, the expert data Be and the agent data Ba each include a plurality of pieces of observation data oₜ, a plurality of pieces of action data aₜ, a plurality of pieces of reward data rₜ, and domain information y. The observation data oₜ indicates an image as an observation result at each time t. The action data aₜ indicates a command to operate the robot 10 at time t. The step width and the starting time of the time t can be appropriately set.

In the present embodiment, the domain information y indicates a label of a type of data for classifying the expert data Be and the agent data Ba by the value “0” or “1”. In the present embodiment, the expert data Be is an example of the first series data, and the agent data Ba is an example of the second series data.

In the example of FIG. 4, in the observation data oₜ of the expert data Be, a finger of the human 12 appears in a partial region R10. On the other hand, in the example of FIG. 5, in the observation data oₜ of the agent data Ba, the end effector of the robot 10 is shown in the region R11 corresponding to the above. Such a difference between the two pieces of data Be and Ba is an example of a domain shift. In addition to such reflection of the human 12, examples of the domain shift include an illumination condition at the time of capturing of the camera 11, an installation position of a sensor device such as the camera 11, a creation place and a creation time of each of the data Be and Ba, a type or individual difference of the robot 10, and a difference in modality of each of the data Be and Ba.

Returning to FIG. 3, the identification model 31 constitutes an identifier that identifies the expert operation and the agent operation, based on a part of the input series data B1 including the expert data Be or the agent data Ba. The identification model 31 is a learning model such as a neural network, and is trained so as to improve the accuracy of identification between the expert operation and the agent operation.

The imitation learning of the present embodiment is performed such that the identification model 31 as described above erroneously recognizes the agent operation as the expert operation. For example, due to the domain shift between the expert data Be and the agent data Ba such as the presence or absence of the reflection of the human 12, there may be a problem causing difficulty to achieve the imitation learning as the identification model 31 uses the domain shift as a basis of identification. To this end, in the present embodiment, machine learning that deteriorates the accuracy of identification by the identification model 31 is performed on the state space model 4 (details will be described later) to solve the above problem. As a result, even if there is a domain shift, it is possible to easily achieve the imitation learning.

The state space model 4 is a learning model that learns representations of states corresponding to various feature values in the input series data B1. The state space model 4 calculates a current deterministic state hₜ and a stochastic state sₜ, based on the past observation o_{≤t} before the present and a past, and action a_{<t} before the present. The machine learning of the state space model 4 in the present embodiment is performed by including a term considering a loss function L_{D} of the identification model 31 in a loss function L_{DA} of the state space model 4. Details of the state space model 4 will be described later.

The reward model 32 constitutes a reward estimator that calculates a reward related to the states hₜ and sₜ expressed by the state space model 4. The reward model 32 includes a learning model such as a neural network.

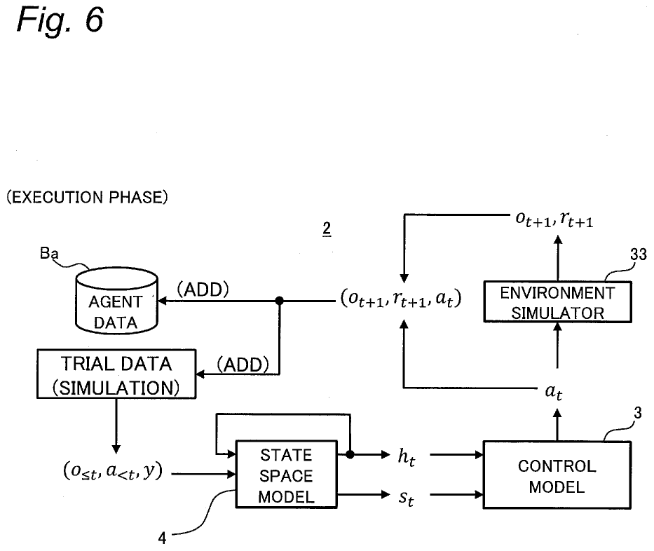

FIG. 6 is a block diagram illustrating a functional configuration of an execution phase in the information processing apparatus 2. The information processing apparatus 2 further includes a control model 3 as a functional configuration of the processor 20, for example. The information processing apparatus 2 may further include an environment simulator 33.

The control model 3 constitutes a controller that controls the robot 10 or the environment simulator 33. In the present embodiment, the control model 3 sequentially generates the action data aₜ by model prediction control based on the prediction result of the state and the transition thereof by the state space model 4, to determine a new action of the robot 10 or the like. At this time, the control model 3 uses values output from the identification model 31 and the reward model 32. The control model 3 may include the identification model 31 and the reward model 32.

The environment simulator 33 is constructed to reproduce the robot 10 and its action, for example. The environment simulator 33 generates observation data oₜ₊₁ so as to indicate a result observed after the reproduced action of the robot 10. The environment simulator 33 may be provided outside the information processing apparatus 2. In this case, the information processing apparatus 2 can communicate with the environment simulator 33 via the device I/F 24, for example.

Trial data generated during the simulation of the execution phase as described above is sequentially updated by adding the observation data oₜ₊₁ and the action data aₜ thereto. In the system 1, the agent data Ba can be generated by accumulating the observation data oₜ₊₁ and the action data aₜ generated in the environment simulator 33, for example. The agent data Ba can be generated similarly to the described above, even in a case of using the real robot 10 and the camera 11 and the like instead of the environment simulator 33.

### 1-3-1. State Space Model

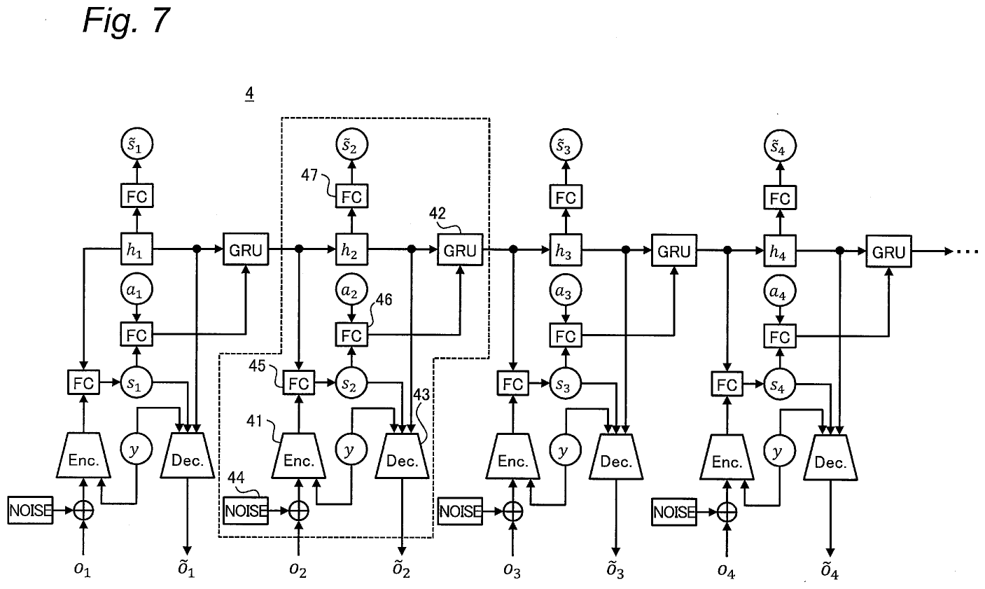

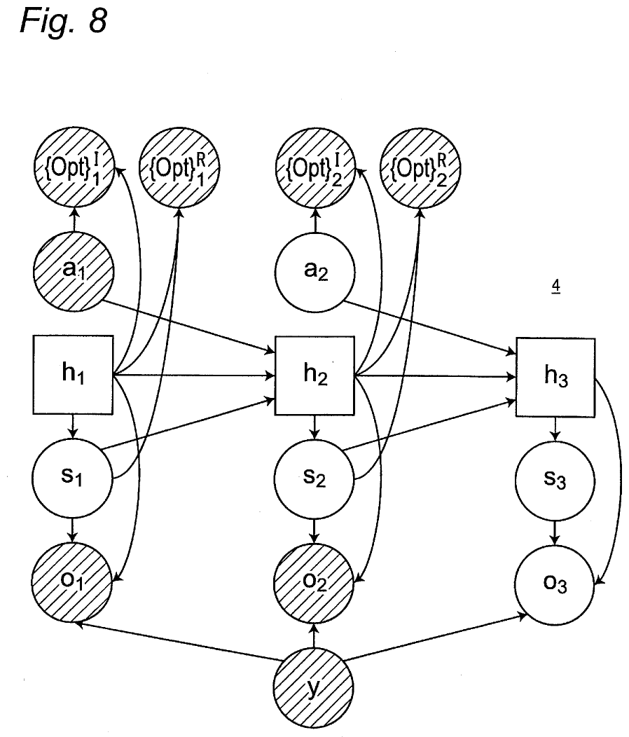

Details of the state space model 4 in the information processing apparatus 2 of the present embodiment will be described with reference to FIGS. 7 and 8.

FIG. 7 is a diagram illustrating a configuration of the state space model 4 in the present embodiment. In FIG. 7, the state space model 4 is illustrated in a form developed with respect to time t. The superscript “˜” in the drawing is denoted as “/” in the specification (e.g., /sₜ, /oₜ).

As illustrated in FIG. 7, the state space model 4 includes an encoder 41, a transition predictor 42, a decoder 43, a noise adder 44, and a plurality of full coupling layers 45, 46, 47, for example. The state space model 4 of the present embodiment operates by inputting the domain information y to the encoder 41 and the decoder 43.

The encoder 41 performs feature extraction for inferring the stochastic state sₜ at the same time t on the basis of the observation data oₜ and the domain information y at the current time t. For example, the encoder 41 is a neural network such as a convolutional neural network.

The transition predictor 42 performs operation to predict a deterministic state hₜ₊₁ at the next time (t+1), based on the current action data aₜ and the stochastic state sₜ. For example, the transition predictor 42 is a gated recurrent unit (GRU). The deterministic state hₜ at each time t corresponds to a latent variable holding context information indicating a history from the past before the time t in the GRU. The transition predictor 42 is not limited to GRU, and may be a cell of various recurrent neural networks, e.g. a long short term memory (LSTM).

The decoder 43 generates observation data /oₜ obtained by reconstructing the current observation data oₜ on the basis of the current states hₜ, sₜ and the domain information y. For example, the decoder 43 is a neural network such as a deconvolutional neural network. The encoder 41 and the decoder 43 constitute a variational autoencoder that uses the domain information y as a condition.

In the present embodiment, the noise adder 44 sequentially adds predetermined noise to the observation data oₜ input to the encoder 41, for example. For example, the predetermined noise is Gaussian noise, salt-and-pepper noise, or impulse noise. According to the noise adder 44, it is possible to achieve an effect of reducing the influence of the domain shift by using the noise that is easily removed in feature extraction. The noise adder 44 may add noise to various states hₜ, sₜ, /sₜ alternatively or additionally to the input of the encoder 41. Also in this case, the similar effect to that described above can be achieved. The noise adder 44 may not be particularly included in the state space model 4.

In the example of FIG. 7, one or more full coupling layers 45 that couple the output value from the encoder 41 and the current deterministic state hₜ are provided, and the stochastic state sₜ is output from the full coupling layers 45. In this example, the action aₜ at the time t and the stochastic state sₜ are coupled in one or more full coupling layers 46 and then input to the transition predictor 42. Furthermore, in this example, one or more full coupling layers 47 that generate a state /sₜ corresponding to the stochastic state sₜ on the basis of the deterministic state hₜ are provided. The state space model 4 of the present embodiment is not particularly limited to the above configuration. For example, the full coupling layer 46 may be included in the transition predictor 42.

FIG. 8 illustrates a graphical model of the state space model 4. Arrows in the drawing indicate generation processes, and shaded portions indicate observable variables. For example, the stochastic state sₜ at the time t is obtained from the deterministic state hₜ at the same time t by the generation process.

The state space model 4 of the present embodiment is configured by further applying the domain information y to the input side and applying imitation optimality {Opt}^{I}ₜ and task optimality {Opt}^{R}ₜ to the output side in a recurrent state space model (RSSM) of Danijar Hafner et al., “Learning Latent Dynamics for Planning from Pixels”, arXiv preprint arXiv: 1811.04551, November 2018 (hereinafter “Non-Patent Document 2”), for example.

The imitation optimality {Opt}^{I}ₜ indicates whether the imitation at the time t is optimal or not by “1” or “0”. The probability that the imitation optimality {Opt}^{I}ₜ is “1” corresponds to D(hₜ, aₜ) that is an output value of the identification model 31 (hereinafter, sometimes referred to as “imitation probability D(hₜ, aₜ)”).

The task optimality {Opt}^{R}ₜ indicates the optimality regarding the task at the time t by “1” or “0”. The probability with the task optimality {Opt}^{R}ₜ being “1” is expressed as “exp(r(hₜ, sₜ))” by applying an exponential function to r(hₜ, sₜ) that is an output value of the reward model 32.

### 2. Operation

The operation of the information processing apparatus 2 configured as described above will be described below.

### 2-1. Operation of Learning Phase

The operation of the learning phase in the information processing apparatus 2 of the present embodiment will be described with reference to FIG. 3.

In the learning phase, the processor 20 of the information processing apparatus 2 prepares the input series data B1 to include observation data o_{≤t} and action data a_{≤t} on or before the time t in one of the expert data Be and the agent data Ba, and the corresponding domain information y. In the input series data B1, the observation data o_{≤t} on or before the time t, the action data a_{<t} before the time t, and the domain information y are input to the state space model 4. For example, the action data aₜ on the last time t is input to the identification model 31.

The state space model 4 operates the encoder 41, the transition predictor 42, and the decoder 43 in FIG. 7, based on the input data (o_{≤t}, a_{<t}, y). In this example, the state space model 4 outputs the deterministic state hₜ at the time t to the identification model 31 and the reward model 32, and outputs the stochastic state sₜ at the same time t to the reward model 32.

The identification model 31 calculates an imitation probability D(hₜ, aₜ) as an identification result of the expert operation and the agent operation within a range of “1” to “0” on the basis of the input data (hₜ, aₜ). The imitation probability D(hₜ, aₜ) is closer to “1” as the identification model 31 is more likely to identify the operation as the expert operation. The imitation probability D(hₜ, aₜ) is closer to “0” as the identification model 31 is more likely to identify the operation as the agent operation. The reward model 32 calculates a reward function r(hₜ, sₜ), based on the input data (hₜ, sₜ). The machine learning of the various models 4, 31, 32 is performed by calculating each loss function according to the operation as described above.

According to the operation of the state space model 4 at the time t=T, the loss function L_{RSSM} in the following Equation (10) can be calculated, for example.

$$ln p ( {o}_{1 : T} \vert {a}_{1 : T} ) \geq {\sum }_{t = 1}^{T} {𝔼}_{q ( {s}_{t - 1} \vert {o}_{\leq t - 1} , {a}_{< t - 1} , y )} [ ln p ( {o}_{t} \vert f ( {h}_{t - 1} , {s}_{t - 1} , {a}_{t - 1} ) , {s}_{t} , y ) - KL [ q ( {s}_{t} \vert {o}_{\leq t} , {a}_{< t} , y ) ‖ p ( {s}_{t} \vert f ( {h}_{t - 1} , {s}_{t - 1} , {a}_{t - 1} ) ) ] ] = - {ℒ}_{RSSM} \qquad ( 10 )$$

The above Equation (10) is derived by variational inference regarding the log likelihood ln(p(o_{1:T}|a_{1:T})) at time t=1 to T (see Non-Patent Document 2). The middle side of the above Equation (10) takes a total sum Σ from time t=1 to time t=T for an expected value E of a first term and a second term over posterior distribution q (sₜ₋₁|o_{≤t-1}, a_{<t-1}, y) corresponding to the encoder 41. The first term of the middle side takes a natural logarithm ln of probability distribution p(oₜ|hₜ, sₜ, y) corresponding to the decoder 43. The second term of the middle side indicates Kullback-Leibler divergence KL between the posterior distribution q (sₜ|o_{≤t}, a_{<t}, y) and the probability distribution p(sₜ|hₜ) The transition predictor 42 corresponds to f (hₜ₋₁, sₜ₋₁, aₜ₋₁)=hₜ.

The loss function L_{D} of the identification model 31 is expressed by the following Equation (11).

[symbol]

= [symbol] _{π}_{_{θ}}[ln [symbol] (hₜ, aₜ)]+ [symbol] _{π}_{_{E}}[ln(1− [symbol] (hₜ, aₜ)] (11)

In the above Equation (11), the first term on the right side indicates the expected value E obtained by taking the natural logarithm ln of the imitation probability D(hₜ, aₜ) with respect to the agent operation. π_{θ} represents a measure of the agent operation. The second term on the right side indicates the expected value E obtained by taking the natural logarithm ln of (1−D(hₜ, aₜ)) with respect to the expert operation. π_{E} represents a measure of the expert operation.

The machine learning of the identification model 31 is performed by the processor 20 optimizing a weight parameter in the identification model 31 so as to minimize the loss function L_{D} of the above Equation (11). As a result, the identification model 31 is trained so as to reduce an error in identifying between the agent operation and the expert operation and to improve the identification accuracy.

On the other hand, in the present embodiment, the loss function L_{DA} applied to the machine learning of the state space model 4 includes a term that deteriorates the identification accuracy of the identification model 31 as in the following Equation (12).

[symbol]

_{DA}= [symbol] _{RSSN}−λ [symbol] (12)

In the above Equation (12), the hyperparameter λ has a positive value being larger than “0”.

The machine learning of the state space model 4 is performed by optimizing a weight parameter in the state space model 4 by the processor 20 so as to minimize the loss function L_{DA} of the above Equation (12). The first term on the right side in the above Equation (12) is set according to the configuration of the state space model 4 and is expressed by e.g. Equation (10). The second term on the right side is a penalty term that deteriorates the identification accuracy of the identification model 31 as including the loss function L_{D} of the identification model 31 in the negative sign.

According to the above machine learning, the state space model 4 and the identification model 31 are trained as if adversarial. Thus, it is possible to perform the state representation learning of acquiring the representations of the states hₜ, sₜ such that the state space model 4 hides the domain shift between the expert data Be and the agent data Ba.

In the present embodiment, the loss function L_{DA} applied to the machine learning of the state space model 4 includes a term that deteriorates the identification accuracy of the identification model 31. However, the present embodiment is not limited to this. For example, a gradient reversal layer as described in Yaroslav Ganin et al., “Domain-Adversarial Training of Neural Networks”, The Journal of Machine Learning Research, January 2016 may be inserted between the state space model 4 and the identification model 31. The gradient reversal layer is a layer that performs an identity mapping at the time of forward propagation and performs an operation of inverting the sign of the gradient (e.g., multiplying by −1) at the time of back propagation. This also enables the state space model 4 to perform state representation learning for acquiring representations of the states hₜ, sₜ that hide the domain shift between the expert data Be and the agent data Ba. In short, it is sufficient that the state space model 4 can infer a state representation that deteriorates the identification accuracy of the identification model 31.

In the present embodiment, the domain information y is used for the state space model 4 to stabilize the machine learning with respect to the variation of the hyperparameter λ. In the state space model 4, the decoder 43 to which the domain information y is input is trained to reduce an error for restring the observation data oₜ according to the first term of the loss function L_{RSSM} (see the first term of Equation (10)). The encoder 41 to which the domain information y is also input is trained together with the transition predictor 42 (see the second term of Equation (10)) so that the stochastic state sₜ to be inferred is consistent with the result generated from the deterministic state hₜ (see FIG. 8).

The machine learning of the reward model 32 is performed by optimizing a weight parameter in the reward model 32 so as to minimize a loss function Lᵣ due to a square error with the reward data rₜ as training data as in the following Equation (13), for example.

$${ℒ}_{r} = {\sum }_{t = 1}^{T} {( {r}_{t} - r ( {h}_{t} , {s}_{t} ) )}^{2} \qquad ( 13 )$$

### 2-1-1. Processing of Imitation Learning

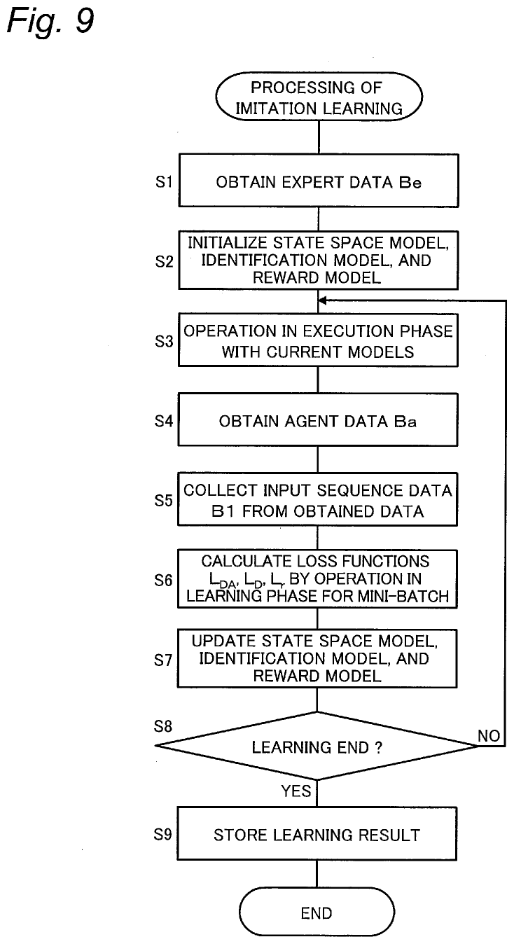

An example of processing to perform the above-described imitation learning will be described with reference to FIG. 9. FIG. 9 is a flowchart illustrating imitation learning processing in the information processing apparatus 2. For example, each processing illustrated in the flowchart of FIG. 9 is performed by the processor 20 of the information processing apparatus 2.

At first, the processor 20 of the information processing apparatus 2 obtains the expert data Be (S1). For example, the processor 20 generates the expert data Be on the basis of the captured image of the camera 11 by the direct teaching function of the robot system 1, and stores the expert data Be in the replay buffer of the expert in the temporary memory 21b.

The processor 20 initializes the state space model 4, the identification model 31, and the reward model 32 (S2).

Next, using the current state space model 4, identification model 31, reward model 32, and control model 3 (see FIG. 6), the processor 20 performs the operation in the execution phase (S3). The operation of the execution phase of the information processing apparatus 2 will be described later.

The processor 20 obtains the agent data Ba from the operation result of step S3 (S4). Specifically, the processor 20 generates the agent data Ba together with the operation in step S3, and stores the agent data Ba in the replay buffer of the agent in the temporary memory 21b.

Next, the processor 20 collects the input series data B1 for the mini-batch from the replay buffers of the expert and the agent (S5). For example, the processor 20 extracts a predetermined plurality of (e.g., 1 to 100) pieces of input series data B1 from the expert data Be and the agent data Ba. Each input series data B1 has the same sequence length (e.g., 5 to 100 steps), for example.

The processor 20 calculates the loss functions L_{DA}, L_{D}, Lᵣ by performing the operation of the learning phase with the collected input series data B1 for the mini-batch (S6). The processor 20 sequentially inputs the input series data B1 to the state space model 4 and the like in FIG. 3, and causes the state space model 4, the identification model 31, and the reward model 32 to repeatedly perform the operation in the learning phase. The processor 20 calculates the loss functions L_{DA}, L_{D}, Lᵣ for each by an average value of repeatedly obtained output values, for example.

The processor 20 updates each of the state space model 4, the identification model 31, and the reward model 32, based on the calculation results of the loss functions L_{DA}, L_{D}, Lᵣ (S7). The update of the state space model 4 based on the loss function L_{DA}, the update of the identification model 31 based on the loss function L_{D}, and the update of the reward model 32 based on the loss function Lᵣ may be sequentially performed, for example. Each update can be appropriately performed by changing the weight parameter using an error back propagation method.

The processor 20 repeats the processing of step S3 and subsequent steps, for example, unless a preset learning end condition is satisfied (NO in S8). For example, the learning end condition is set as performing learning for a mini-batch (S5 to S7) by a predetermined number.

When the learning end condition is satisfied (YES in S8), the processor 20 stores information indicating the learning result in the memory 21 (S9). For example, the processor 20 records the weight parameters of each of the learned state space model 4, identification model 31, and reward model 32 in the storage 21a. After storing the learning result (S9), the processor 20 ends the processing illustrated in this flowchart.

According to the above processing, the state space model 4 is trained so as to minimize the loss function L_{DA} including the term that maximizes the loss function L_{D} of the identification model 31 as well as training the identification model 31 so as to minimize the loss function L_{D} using each of the data Be and Ba (S6, S7). As a result, it is possible to cause the state space model 4 to be learned so as to acquire a state in which the domain shift between both the data Be and Ba is hidden.

The learning method described above is an example, and various changes can be made. For example, in the above description, an example of performing mini-batch learning (S5 to S7) has been described; however, the learning method in the present embodiment is not particularly limited thereto, and may be batch learning or online learning.

In step S1 described above, the expert data Be may be generated by numerical simulation in a laboratory or the like, for example. For example, the processor 20 may generate the expert data Be using the environment simulator 33. In step S1, the processor 20 may read the expert data Be stored in advance in the storage 21a to the temporary memory 21b.

At the time of re-learning of each of the models 4, 31, 32, the previous learning result may be appropriately used as the initial value set in step S2. The operation in step S3 may use the environment simulator 33 or the real robot 10.

### 2-2. Operation of Execution Phase

Hereinafter, the operation of the execution phase of the information processing apparatus 2 in the present system 1 will be described.

In the robot system 1 of the present embodiment, the information processing apparatus 2 in the execution phase sequentially obtains the observation data oₜ from the camera 11 (or the simulation result), to accumulate the observation data oₜ in the memory 21, for example. The processor 20 of the information processing apparatus 2 also accumulates action data a₁ to aₜ₋₁ from the past to the present. For example, the processor 20 sets the domain information y to “y=1 (agent)”, inputs the accumulated data (o_{≤t}, a_{<t}) to the state space model 4 or the like in FIG. 6, and causes the control model 3 to work using the output of the state space model 4 or the like. The control model 3 outputs the current action data aₜ by the model prediction control, and determines an action to be performed by the robot 10 from now. By repeating such operations, the robot system 1 can be feedback-controlled.

### 2-2-1. Model Prediction Control

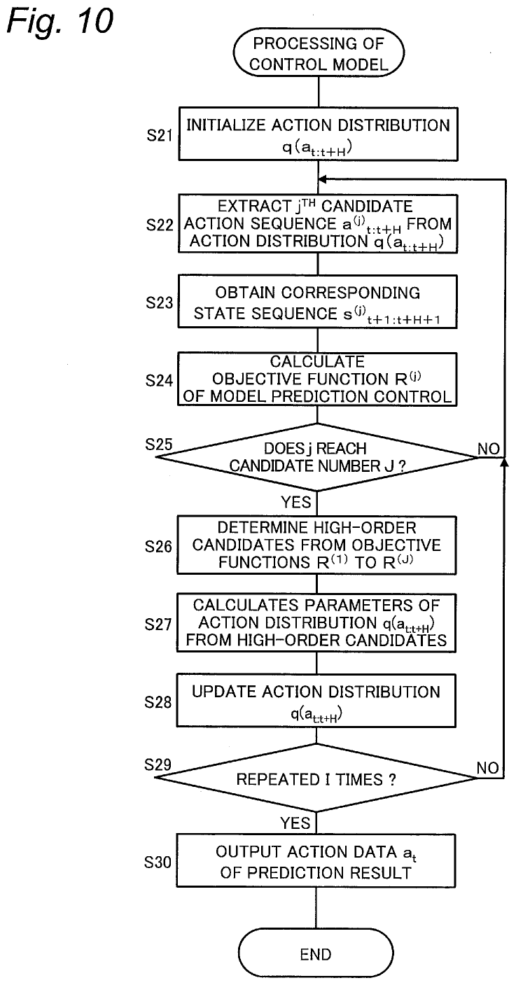

Processing of the above-described model prediction control by the control model 3 will be described with reference to FIG. 10. Hereinafter, an example of processing for performing the model prediction control based on the cross entropy method will be described.

FIG. 10 is a flowchart illustrating processing of the control model 3 in the information processing apparatus 2. For example, each processing illustrated in the flowchart of FIG. 10 is performed by the processor 20 serving as the control model 3.

At first, the processor 20 serving as the control model 3 initializes action distribution q(a_{t:t+H}) that is the distribution of an action sequence a_{t:t+H} (S21). The action sequence a_{t:t+H} includes (H+1) pieces of action data aₜ to a_{t+H} from time t to time (t+H) in order. H is a range of the planning horizon distance, that is, the time t predicted in the model prediction control, and is appropriately set to a predetermined value (e.g., H=0 to 30). In step S21, the action distribution q(a_{t:t+H}) is set to an average “0” and a variance “1” in a (H+1)-dimensional normal distribution, for example.

Next, the processor 20 extracts candidate action sequence a^{(j)}_{t:t+H} from distribution q(a_{t:t+H}) of the current action sequence (S22). The candidate action sequence a^{(j)}_{t:t+H} is sequentially extracted from the first action sequence to the J-th action sequence each time step S22 is performed (j=1 to J). J is a predetermined number of candidates, and is preset to e.g. J=100 to 10000.

The processor 20 obtains the j-th state sequence s^{(j)}_{t+1:t+H+1} (S23). The state sequence s^{(j)}_{t+1:t+H+1} includes (H+1) deterministic states s^{(j)}ₜ₊₁ to s^{(j)}_{t+1:t+H+1} from time (t+1) to time (t+H+1) in order. The processing of step S23 is performed by calculating posterior distribution q(s^{(j)}_{τ}|h^{(j)}_{τ}) with the transition predictor 42 and the encoder 41 of the state space model 4 (τ=t+1 to t+H+1), for example.

Next, the processor 20 calculates an objective function R^{(j)} of the model prediction control, based on the j-th candidate action sequence a^{(j)}_{tt:t+H} and the state sequence s^{(j)}_{t+1:t+H+1} (S24). The objective function R^{(j)} is expressed by the following Equation (21).

[symbol]

=Σ_{τ=t+1}^{t+H+1}ln [symbol] +r(h_{τ}^{(j)}, s_{τ}^{(j)}) (21)

The right side of the above Equation (21) takes the sum Σ of the first term and the second term from the time τ=t+1 to t+1+H. The first term of the right side takes a natural logarithm ln of the imitation probability D(h^{(j)}_{τ-1}, a^{(j)}_{τ-1}) of the time (τ−1). The second term on the right side indicates the reward at the time τ estimated by the reward model 32, and is obtained by calculation of a reward function r(h^{(j)}_{τ}, s^{(j)}_{τ}), for example.

The processor 20 repeats the processing of steps S22 to S24 described above J times (S25). As a result, J candidate action sequences a⁽¹⁾_{t:t+H} to a^{(j)}_{t:t+H} and the like are obtained, and objective function R^{(j)} for each is calculated.

Next, the processor 20 determines a higher-order candidate from among the J candidates, based on the calculated objective function R^{(j)} (S26). For example, the processor 20 determines K candidates as high-order candidates in descending order of the calculated value of the objective function R^{(j)}. The number of high-order candidates K is appropriately set within a range smaller than the number of candidates J (e.g., K=10 to 200).

Next, the processor 20 calculates an average μ_{t:t+H} and a standard deviation σ_{t:t+H}, which are parameters of the action distribution q(a_{t:t+H}) as a normal distribution, as in the following Equation (22), based on the determined high-order candidates(S27).

$${μ}_{t : t + H} = \frac{1}{K} {\sum }_{k ∈ K} {a}_{t : t + H}^{( k )} \qquad ( 22 )$$

$${σ}_{t : t + H} = \frac{1}{K - 1} {\sum }_{k ∈ K} \vert {a}_{t : t + H}^{( k )} - {μ}_{t : t + H} \vert$$

where, the average μ_{τ} at each time τ(τ=t to t+H) is calculated by an average value of K pieces of action data a^{(k)}_{τ} of the high-order candidates at the same time τ. The standard deviation o at each time τ is calculated as an average value of magnitudes of differences between the action data a^{(k)}_{τ} of the K high-order candidate and the average μ_{τ} at the same time τ.

Next, the processor 20 updates the action distribution q(a_{t:t+H}) as in the following Equation (23) according to the calculated average μ_{t:t+H} and standard deviation σ_{t:t+H} (S28).

q(a_{t:t+H})← [symbol] (μ_{t:t+H}, σ²_{t:t+H} [symbol] ) (23)

The update of the action distribution q(a_{t:t+H}) as described above is repeated I times set in advance (e.g., I=5 to 30). That is, when the current number of repetitions is less than I (NO in S29), the processor 20 repeats the processing onward step S22 by using updated action distribution q(a_{t:t+H}). As a result, the candidate action sequence a^{(j)}_{t:t+H} or the like is obtained again using the updated action distribution q(a_{t:t+H}), and the accuracy of the candidate can be improved.

When the processing of steps S22 to S28 is repeated I times (YES in S29), the processor 20 finally outputs the average μₜ at the time t as the prediction result of the action data aₜ (S30).

When the processor 20 serving as the control model 3 outputs the action data aₜ of the prediction result at the time t (S30), the processing illustrated in this flowchart is terminated. The processor 20 serving as the control model 3 repeatedly performs the above processing, in a cycle of a pitch width at time t, for example.

According to the above processing, the feedback control of the robot 10 can be achieved by repeating the model prediction control using the state space model 4 or the like that has undergone state representation learning in the information processing apparatus 2 of the present embodiment.

### 2-3. Experiment of Imitation Learning

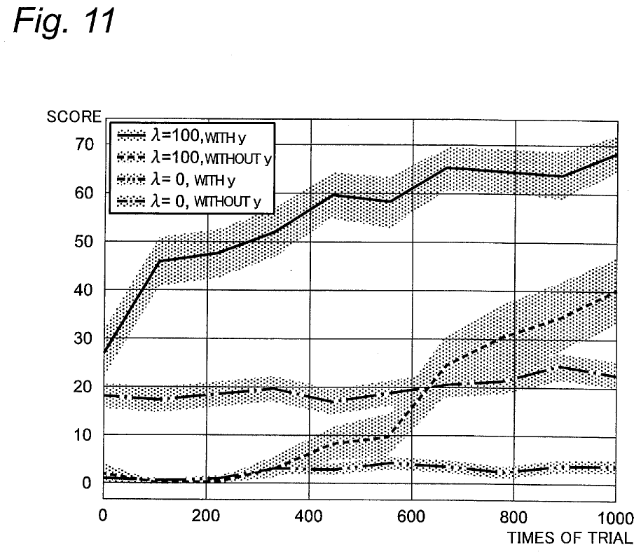

An experimental result of verifying the effect of the imitation learning by the information processing apparatus 2 and the information processing method as described above will be described with reference to FIGS. 11 to 14.

FIG. 11 is a graph illustrating a first experimental result regarding imitation learning of the present embodiment. In FIG. 11, the horizontal axis represents the number of trials of learning, that is, the number of episodes, and the vertical axis represents the score of the benchmark. The shaded range in the drawing indicates the confidence interval of the score.

In the experiment of FIG. 11, the imitation learning by the same model configuration was performed for the case of λ>0, and in the case of λ=0 in Equation (12), what is, for the cases of whether using the loss function L_{DA} of the state space model 4 in the present embodiment. Furthermore, in each case of λ>0 and λ=0, the effect of the presence or absence of the domain information y was also verified. The hyperparameter λ when λ>0 was set to “λ=100”.

According to this experiment, as illustrated in FIG. 11, in a case where λ>0 and the domain information y is used, a higher score was always obtained than in other cases. Even in the case of λ>0 and no domain information y is used, the score was improved every time the trial was repeated, and a result exceeding that in the case of λ=0 was obtained. As described above, according to the loss function L_{DA} of the state space model 4 in the present embodiment, it was verified that the imitation learning can be performed more accurately than in the case of λ=0.

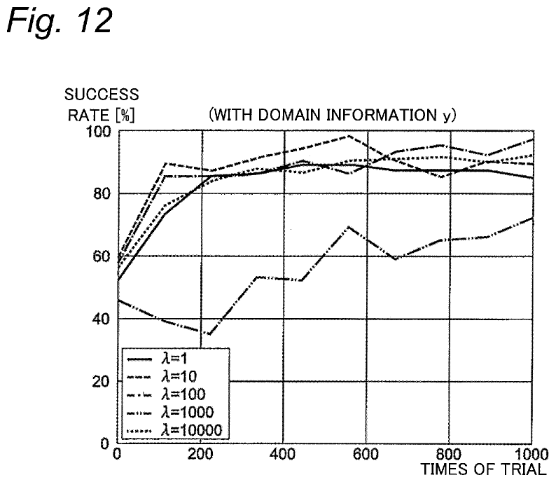

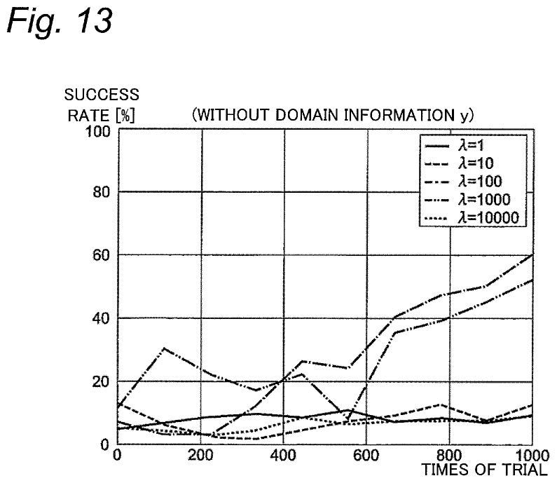

FIG. 12 is a graph illustrating a result in a case of using the domain information y in a second experiment of the present embodiment. FIG. 13 is a graph illustrating a result in a case of using no domain information y in the second experiment. In FIGS. 12 and 13, the horizontal axis represents the number of times of trial of learning, and the vertical axis represents the success rate [%] of the task.

In the experiment of FIG. 12, the result of using the loss function L_{DA} of the state space model 4 in the present embodiment with the hyperparameter λ being changed was compared between the case with the domain information y and the case without the domain information y. The hyperparameter λ was set to “λ=1, 10,100, 1000, 10,000”.

According to this experiment, in the case with the domain information y, a relatively high success rate was obtained even if the hyperparameter λ changes, as illustrated in FIG. 12. On the other hand, in the case without the domain information y, as illustrated in FIG. 13, the success rate increased if λ=100, 1000. However, if the hyperparameter λ becomes higher or lower than that in this case, the success rate did not increase. Therefore, it was verified that the accuracy of learning with respect to the variation of the hyperparameter λ can be stabilized by using the domain information y when the loss function L_{DA} of Equation (12) is used for the state space model 4 of the present embodiment.

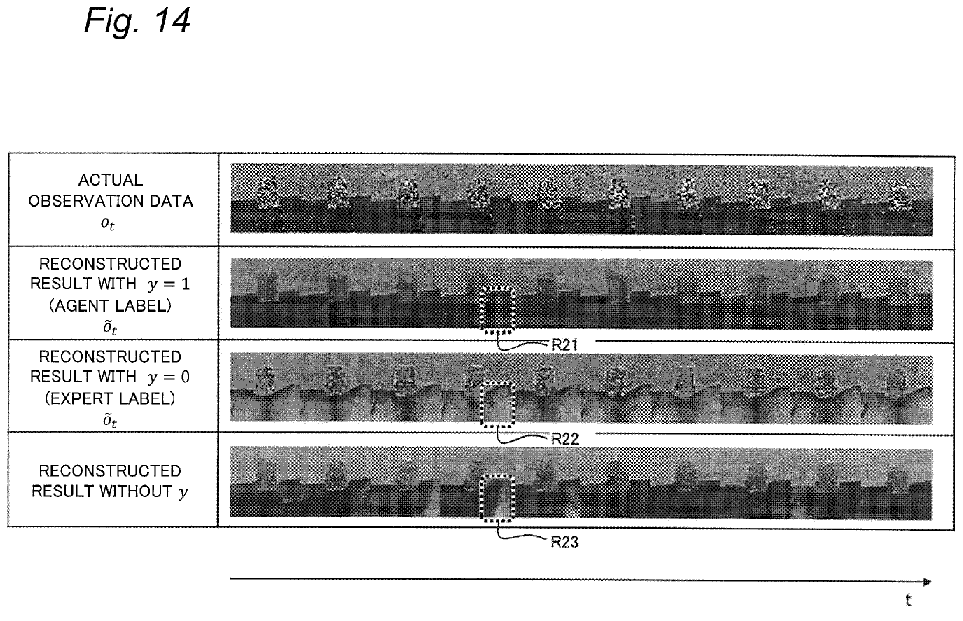

FIG. 14 is a table illustrating a third experimental result regarding imitation learning of the present embodiment. In the experiment of FIG. 14, after learning using the loss function L_{DA} of the state space model 4 and the domain information y in the present embodiment, an experiment of changing the domain information y input to the decoder 43 was performed.

The first row of FIG. 14 shows actual observation data oₜ. The observation data oₜ in this case was generated by simulation, and was the agent data Ba, for example. The right direction in the drawing corresponds to the time t.

As illustrated in FIG. 7, when the observation data oₜ is input, the state space model 4 generates the states sₜ, hₜ by the encoder 41 or the like, for example. The decoder 43 of the state space model 4 generates the observation data /oₜ of the reconstruction result, based on the generated states sₜ, hₜ and the domain information y.

The second row of FIG. 14 shows a reconstruction result of the decoder 43 in a case where the domain information y is set to y=1, that is, the agent. The third row of FIG. 14 shows a reconstruction result of the decoder 43 in a case where the domain information y is set as y=0, that is, the expert. The fourth row of FIG. 14 shows a reconstruction result without using domain information.

Regarding the fourth row of FIG. 14, in this experiment, at the time of learning the state space model 4, a decoder not using the domain information y in the same configuration as the decoder 43 was learned in parallel. The fourth row of the FIG. 14 shows a result of reconstructing the observation data oₜ of the first row of the drawing by such an experimental decoder on the basis of the same information as the states sₜ, hₜ input to the decoder 43.

According to the present experiment, the end effector of the robot 10 or the finger of the human 12 was reconstructed on the image according to the domain information y as shown in the regions in second and third rows of FIG. 14 (e.g., the regions R21, R22). As shown in the fourth row of FIG. 14, when the domain information y was not used, an image that cannot be distinguished from both the end effector of the robot 10 and the finger of the human 12 was obtained (e.g., region R23). This indicates that the states sₜ, hₜ obtained from the input observation data oₜ do not include information indicating that the data oₜ belongs to the domain of the agent. Therefore, according to this experiment, it was verified that the state representation learning of the present embodiment can make the state space model 4 possible to acquire the states sₜ, hₜ in which the domain shift is hidden.

### 3. Conclusion

As described above, in the present embodiment, the information processing apparatus 2 includes the memory 21 and the processor 20. The memory 21 stores the expert data Be, which is an example of first series data including a plurality of pieces of observation data oₜ, and the agent data Ba, which is an example of second series data different from the expert data Be. The processor 20 performs machine learning of the state space model 4 and the identification model 31, which are learning models, respectively, by calculating a loss function for each learning model, based on the data Be and Ba. The state space model 4 includes the encoder 41, the decoder 43, and the transition predictor 42. The encoder 41 calculates a state to be inferred, based on one of at least part of the expert data Be and at least part of the agent data Ba. The decoder 43 reconstructs at least part of each of the data Be and Ba from the state. The transition predictor 42 predicts a transition of the state. The identification model 31 identifies whether the state is based on the expert data Be or the agent data Ba. The loss function L_{DA} of the state space model 4 includes a term “−λL_{D}” that deteriorates the accuracy of identification by the identification model 31.

According to the information processing apparatus 2 described above, the domain-dependent information in each of the data Be and Ba is automatically removed from the state acquired by the state space model 4 through learning by the −λL_{D} term in the loss function L_{DA} of the state space model 4. As a result, it is possible to suppress the influence of the domain shift and to facilitate the imitation learning. For example, the transition prediction by the transition predictor 42 or the characteristic amount regarding the desired control can be appropriately extracted regardless of the domain shift. Therefore, even when the domains of the expert data Be and the agent data Ba are different, the agent can imitate the operation of the expert.

In the present embodiment, the processor 20 inputs the domain information y, which indicating one type among the types of data classifying the expert data Be and the agent data Ba, into the decoder 43 and the encoder 41, to perform machine learning of the state space model 4. As a result, it is possible to stabilize the accuracy of the machine learning with respect to the variation of the hyperparameter λ of the −λL_{D} term of the loss function L_{DA} of the state space model 4 and to more easily perform the imitation learning.

In the present embodiment, the decoder 43 changes the reconstruction result from the state according to the type of data indicated by the domain information y (see FIG. 14). The encoder 41 can also be configured to change the behavior according to the type of data indicated by the domain information y.

In the present embodiment, the information processing apparatus 2 further includes the noise adder 44 that adds noise to at least one of the observation data oₜ and the states hₜ, sₜ, /sₜ. By the noise adder 44, the influence of the domain shift can be alleviated during learning, and the imitation learning can be efficiently performed, for example.

In the present embodiment, each of the data Be and Ba further includes action data aₜ indicating a command to operate the robot system 1 which is an example of a system to be controlled. Machine learning applicable to control of the robot system 1 can be performed using such action data aₜ.

In the present embodiment, the robot system 1 includes the robot 10 and the camera 11 that is an example of the sensor device that observes the robot 10. The expert data Be can be generated on the basis of a captured image which is an observation result of the camera 11 by, for example, the direct teaching function of the robot system 1. The expert data Be may be generated by such numerical simulation regarding the system 1.

In the present embodiment, the information processing apparatus 2 includes the control model 3 that generates new action data aₜ on the basis of at least part of each of the data Be and Ba, to determine an action of a control target such as the robot 10. Control of the system 1 can be achieved using the control model 3.

In the present embodiment, the agent data Ba can be generated by controlling the system 1 according to the control model 3, for example. The agent data Ba may be generated by numerical simulation regarding the operation of the execution phase of the system 1.

In the present embodiment, the control model 3 determines an action by model prediction control based on a prediction result of a state and a transition by the state space model 4 (see FIG. 10). As a result, it is possible to achieve control imitating the expert using the state acquired by the state space model 4.

In the present embodiment, the argument of the objective function R^{(j)} in the model prediction control includes a value output from the identification model 31 as shown in Equation (21). As a result, an action that the identification model 31 identifies as being close to the expert can be adopted for control of the system 1.

In the present embodiment, the information processing apparatus 2 further includes the reward model 32 that calculates a reward related to the states hₜ, sₜ. The argument of the objective function R^{(j)} in the model prediction control includes a value output from the reward model 32 as shown in Equation (21). As a result, it is possible to adopt an action with a high reward for the control of the system 1.

The information processing method according to the present embodiment includes obtaining, by a computer such as the information processing apparatus 2, first series data including a plurality of pieces of observation data oₜ and second series data different from the first series data (S1, S4); and performing machine learning of the state space model 4 and the identification model 31 that are learning models by calculating a loss function for each learning model, based on the first and second series data (S6, S7). The state space model 4 calculates a state inferred on the basis of at least one of at least part of the first series data and at least part of the second series data, reconstructs at least part of the each of data Be and Ba from the state, and predicts a transition of the state. The identification model 31 identifies whether the state is based on the expert data Be or the agent data Ba. The loss function L_{DA} of the state space model 4 includes a −λL_{D} term that deteriorates the accuracy of discrimination by the identification model 31.

According to the above information processing method, it is possible to facilitate the imitation learning regardless of the domain shift between the first and second series data. According to the present embodiment, a program for causing a computer to perform the information processing method as described above is provided.

### Other Embodiments

As described above, the first embodiment has been described as an example of the technology disclosed in the present application. However, the technology in the present disclosure is not limited thereto, and can also be applied to embodiments in which changes, substitutions, additions, omissions, and the like are made as appropriate. In addition, it is also possible to combine the components described in the above embodiment to form a new embodiment. Therefore, another embodiment will be exemplified below.

In the first embodiment described above, an example has been described in which the domain information y is input into the decoder 43 and the encoder 41 to perform machine learning of the state space model 4. In the present embodiment, the state space model 4 may be configured such that the domain information y is input into either the decoder 43 or the encoder 41. Even in this case, in the machine learning of the state space model 4 using the domain information y, it is possible to ensure stability with respect to the variation of the hyperparameter λ, resulting in facilitating the imitation learning. That is, the processor 20 may input the domain information y, which indicates one type in the types classifying the data as the expert data Be or the agent data Ba, into at least one of the decoder 43 and the encoder 41, and perform machine learning of the state space model 4.

In the above embodiments, an example has been described in which a term “−λL_{D}” that deteriorates accuracy of identification by the identification model 31 is used for machine learning of the state space model 4. However, the present disclosure is not limited to this. For example, as illustrated in FIG. 11, even if λ=0, a higher score is obtained in the case with the domain information y than in the case where without the domain information y. Therefore, according to the information processing method of the present embodiment not using the above term, it is possible to facilitate the imitation learning by the domain information y even when λ=0. Furthermore, in the present embodiment, an information processing apparatus that does not include the identification model 31 may be provided. The identification model 31 may be an external configuration of the information processing apparatus of the present embodiment.

That is, an information processing apparatus of the present aspect embodiment includes a memory and a processor. The memory stores first series data including a plurality of pieces of observation data and second series data different from the first series data. The processor performs machine learning of a state space model, which is a learning model, by calculating a loss function of the learning model, based on the first and second series data. The state space model includes: an encoder that calculates a state inferred on the basis of at least one of at least part of the first series data and at least part of the second series data; a decoder that reconstructs at least part of the first and second series data from the state; and a transition predictor that predicts a transition of the state. The processor inputs domain information, which indicates one type among types of data for classifying the first series data and the second series data, into at least one of the decoder or the encoder, to perform machine learning of the state space model.

The information processing method of the present embodiment includes steps of: obtaining, by a computer, first series data including a plurality of pieces of observation data and second series data different from the first series data; and performing machine learning of the state space model that is a learning model by calculating a loss function for the learning model, based on the first and second series data and. The state space model calculates a state inferred on the basis of at least one of at least part of the first series data and at least part of the second series data, reconstructs at least part of the first and second series data from the state, and predicts a transition of the state. In the performing machine learning, domain information indicating one type among types of data for classifying the first series data and the second series data is input into at least one of the decoder or the encoder, to perform machine learning of the state space model.

Also by the information processing apparatus and the information processing method described above, it is possible to solve the problem of facilitating the imitation learning as in the above embodiments. A program for causing a computer to perform the information processing method as described above may be provided.

In the above embodiments, the camera 11 is exemplified as an example of the sensor device that observes the robot 10. In the present embodiment, the sensor device is not limited to the camera 11, and may be, for example, a force sensor that observes a force sense of the robot 10. The sensor device may be a sensor that observes the position or posture of the robot 10. In the present embodiment, the observation data oₜ may be an arbitrary combination of various observation information such as an image, a force sense, and a position and posture. In addition, the type of such observation data oₜ may be different between the first series data and the second series data. According to the present embodiment, it is possible to suppress the influence of the domain shift due to such a difference in modality similarly to each embodiment described above and achieve the imitation learning.

In the above embodiments, the RSSM has been exemplified as an example of the state space model 4. In the present embodiment, the state space model 4 is not limited to the RSSM, and may be a learning model in various state representation learning.

In the above embodiments, an example in which the first and second series data include the action data aₜ has been described. In the present embodiment, the first and second series data do not necessarily include the action data aₜ. Even in this case, it is possible to cause the state space model 4 to acquire a state in which information such as the domain in the first and second series data is automatically removed by a learning method similar to the above. The state space model 4 that has acquired such a state can be applied to various applications in which behaviors of objects in various videos are reproduced in different domains, for example.

In the above embodiments, the imitation learning using the first series data and the second series data has been described. In the present embodiment, third and subsequent series data different from the first and second series data may be used. For example, expert data in a case where the work sites 13 are different may be added as the third series data. Even in such a case, the learning method similar to the above can be performed, by adding a label for identifying each series data in the domain information y, such as “y=2” for the third series data, for example. As a result, it is possible to suppress the influence of the domain shift between pieces of series data and to facilitate the imitation learning.

In the above embodiments, the example in which the model prediction control is performed by the control model 3 has been described. In the present embodiment, the control model 3 is not limited to the model prediction control, and may be a policy model based on reinforcement learning, for example. For example, a policy model can be obtained using the reward based on the reward model 32 described above. The policy model may be optimized simultaneously with the state space model 4.

In the above embodiments, the robot system 1 has been described as an example of the system to be controlled. In the present embodiment, the system to be controlled is not limited to the robot system 1, and may be e.g. a system that performs various automatic operations related to various vehicles, or a system that controls infrastructure facilities such as a dam.

As described above, the embodiments have been described as an example of the technology in the present disclosure. For this purpose, the accompanying drawings and the detailed description have been provided.

Therefore, the components described in the accompanying drawings and the detailed description may include not only components essential for solving the problem but also components that are not essential for solving the problem in order to illustrate the above technology. Therefore, it should not be immediately recognized that these non-essential components are essential based on the fact that these non-essential components are described in the accompanying drawings and the detailed description.

In addition, since the above-described embodiments are intended to illustrate the technology in the present disclosure, various changes, substitutions, additions, omissions, and the like can be made within the scope of the claims or equivalents thereof.

The present disclosure is applicable to control of various systems such as robots, automatic driving, and infrastructure facilities.

1. An information processing apparatus comprising:
a memory that stores first series data including a plurality of pieces of observation data, and second series data different from the first series data; and
a processor that performs machine learning of a state space model and an identification model that are learning models, by calculating a loss function for each learning model, based on the first and second series data,
the state space model including
an encoder that calculates a state to be inferred based on either one of at least part of the first series data or at least part of the second series data,
a decoder that reconstructs at least part of the first and second series data from the state, and
a transition predictor that predicts a transition of the state,
wherein the identification model identifies whether the state is based on the first series data or the second series data, and
the loss function of the state space model includes a term that deteriorates accuracy of identification by the identification model.

2. An information processing apparatus comprising:
a memory that stores first series data including a plurality of pieces of observation data, and second series data different from the first series data; and
a processor that performs machine learning of a state space model that is a learning model, by calculating a loss function for a learning model, based on the first and second series data,
the state space model including
an encoder that calculates a state to be inferred based on either one of at least part of the first series data or at least part of the second series data,
a decoder that reconstructs at least part of the first and second series data from the state, and
a transition predictor that predicts a transition of the state,
wherein the processor inputs domain information into at least one of the decoder or the encoder to perform the machine learning of the state space model, the domain information indicating one type among types classifying data as the first series data or the second series data.

3. The information processing apparatus according to claim 1, wherein the processor inputs domain information into at least one of the decoder or the encoder, to perform the machine learning of the state space model, the domain information indicating one type among types classifying data as the first series data and the second series data.

4. The information processing apparatus according to claim 2,
wherein the decoder changes a reconstruction result from the state according to the type of data indicated by the domain information.

5. The information processing apparatus according to claim 1, further comprising
a noise adder that adds noise to at least one of the observation data and the state.

6. The information processing apparatus according to claim 1,
wherein the first and second series data further include action data indicating a command to operate a system that is to be controlled.

7. The information processing apparatus according to claim 6,
the system including a robot and a sensor device that observes the robot,
wherein the first series data is generated based on an observation result of the sensor device.

8. The information processing apparatus according to claim 6, further comprising
a control model that generates new action data based on at least part of the first and second series data, to determine an action of the system to be controlled.

9. The information processing apparatus according to claim 8,
wherein the second series data is generated by controlling the system according to the control model.

10. The information processing apparatus according to claim 8,
wherein the control model determines the action by model prediction control based on a prediction result of the state and the transition by the state space model.

11. The information processing apparatus according to claim 10,
wherein an argument of an objective function in the model prediction control includes a value output from the identification model.

12. The information processing apparatus according to claim 10, further comprising
a reward model that calculates a reward based on the state,
wherein an argument of an objective function in the model prediction control includes a value output from the reward model.

13. The information processing apparatus according to claim 1,
wherein the observation data includes at least one of an image, a force sense, or a position and posture.

14. An information processing method performed by a computer, comprising:
obtaining first series data including a plurality of pieces of observation data, and second series data different from the first series data; and
performing machine learning of a state space model and an identification model that are learning models, by calculating a loss function for each learning model, based on the first and second series data,
wherein the state space model
calculates a state to be inferred based on either one of at least part of the first series data or at least part of the second series data,
reconstructs at least part of the first and second series data from the state, and
predicts a transition of the state,
the identification model identifies whether the state is based on the first series data or the second series data, and
the loss function of the state space model includes a term that deteriorates accuracy of identification by the identification model.

15. A non-transitory computer-readable recording medium storing program for causing a computer to perform the information processing method according to claim 14.
